(19) United States
(12) Patent Application Publication
(10) Pub. No.: US 2026/0215453 A1
(43) Pub. Date: Jul. 30, 2026

(54) FOOD PRODUCTS COMPRISING A PROLAMIN AND A METHOD OF MAKING FOOD PRODUCTS COMPRISING A PROLAMIN

(71) Applicant: Kraft Foods Group Brands LLC, Chicago, IL (US)

(72) Inventors: Julie Anne Grover, Burlington, WI (US); Allison Therese Trio, Morton Grove, IL (US)

(21) Appl. No.: 19/144,587

(22) PCT Filed: Dec. 18, 2023
(86) PCT No.: PCT/US2023/084550

§ 371 Date: Jun. 30, 2025

Related U.S. Application Data
(60) Provisional application No. 63/436,288, filed on Dec. 30, 2022.

(51) Int. Cl. A23C 20/02; A23J 1/00; A23J 3/14

(52) U.S. Cl. CPC A23C 20/02; A23J 1/006; A23J 3/14

(57) ABSTRACT

A plant-based food product is provided. The plant-based food product includes a prolamin-containing blend that includes a prolamin, a solvent component, an incorporation component, a fat component, and water. The incorporation component includes one or more of a plant-based protein and a starch. The plant-based protein is a non-prolamin protein. A weight ratio of the prolamin to the solvent component is within the range of 0.66:1 to 1.25:1, and the prolamin is incorporated into the prolamin-containing blend. In some examples the plant-based food may be a plant-based cheese product and may have stretching characteristics similar to a dairy-based cheese.

### FIELD

This application relates generally to food products comprising a prolamin.

### BACKGROUND

Some commercially available plant-based cheese products have been able to replicate the color and texture of dairy-based cheese products at refrigerated temperatures but lack other functional characteristics typical of dairy-based cheeses, such as stretch characteristics upon melting or at cooking temperatures. For example, plant-based cheeses that are formed of a starch-based gel, the starch-based gels in these products generally do not soften sufficiently at cooking temperatures and lack the stretching behavior of dairy cheese. At higher cooking temperatures, the starch-based gels in these products generally lose their structure so that the product resembles a sauce rather than a melted dairy cheese. These plant-based cheese products are not well accepted by consumers who expect a cooking and eating experience that replicates dairy-based cheeses.

### BRIEF DESCRIPTION OF THE DRAWINGS

FIG. 1A and FIG. 1B are photographs of an example plant-based food product (FIG. 1A) and a comparative example plant-based food product (FIG. 1B);

FIG. 2A and FIG. 2B are photographs of grilled cheese type products with an example plant-based food product melted therein (FIG. 2A) and a grilled cheese type product with a comparative example plant-based food product melted therein (FIG. 2B);

FIG. 3A through 3J are photographs of example plant-based food products;

FIG. 4A through 4E are photographs of grilled cheese type products with example plant-based food products melted therein;

FIG. 5 is a photograph of a comparative example plant-based food product;

FIG. 6A through 6C are photographs of a comparative example plant-based food product before heating (FIG. 6A), after heating (FIG. 6B), and 24 hours after heating (FIG. 6C);

FIG. 7A through 7C are photographs of a comparative example plant-based food product before heating (FIG. 7A) and after heating (FIG. 7B and FIG. 7C);

FIG. 8A through 8C are photographs of a comparative example plant-based food product before heating (FIG. 8A), after heating (FIG. 8B), and 24 hours after heating (FIG. 8C); and

FIGS. 9A and 9B are photographs of a comparative example plant-based food product before heating (FIG. 9A) and after heating (FIG. 9B).

Elements in the figures are illustrated for simplicity and clarity and have not necessarily been drawn to scale. For example, the dimensions and/or relative positioning of some of the elements in the figures may be exaggerated relative to other elements to help to improve understanding of various aspects of the present invention. Also, common but well-understood elements that are useful or necessary in a commercially feasible aspect are often not depicted in order to facilitate a less obstructed view of these various aspects of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein are food products, which, in some approaches, may be plant-based food products, including plant-based cheese products, including a prolamin. Compared to other proteins, prolamins can provide unique functionalities to food products in which they are included. Prolamins also provide protein content to food products in which they are included. However, prolamins are soluble in a limited number of solvents, which makes the incorporation of prolamins into food products challenging. Described herein is a process for preparing a blend comprising a prolamin that can then be incorporated into food products, such as plant-based cheese products. In one aspect, the prolamin-containing blend is in the form of a dough. For purposes herein, the term “blend” refers to a cohesive mixture. The blend may be smooth without particulates and/or may be free of insolubilized particles. Additionally, or alternatively, the blend may be viscous and/or resemble a batter. The blend is not dry or crumbly and does not have a curdled appearance. For purposes herein, the term “dough” refers to a thick, cohesive, and malleable mixture similar in appearance to a conventional flour-based dough. The dough is not dry or crumbly and does not resemble a batter or other liquid.

The prolamin-containing blend may be included in a food product and may provide stretching characteristics to the food product. In some aspects, the food product is a plant-based cheese product, and the prolamin-containing blend may provide stretching characteristics to the plant-based cheese product that are similar to stretching characteristics of dairy-based cheese. In some other aspects, the food product is a gluten-free bread or other gluten-free food product, and the prolamin-containing blend may provide stretching characteristics to the gluten-free food product that are similar to stretching characteristics of a gluten-based food product. In some other aspects, the food product is a vegan caramel, taffy, marshmallow, or other stretchy food product, and the prolamin-containing blend may provide stretching characteristics to the vegan food product without ingredients of animal origin.

For purposes herein, the term “plant-based food product” refers to food products prepared with proteins of non-animal origin. For purposes herein, the term “plant-based cheese product” refers to cheese analogues or cheese alternatives prepared with proteins of non-dairy origin. In some examples, the term “plant-based” may refer to a product or ingredient that is free of animal-based proteins, such as dairy proteins, and comprises a plant-derived protein.

To prepare the prolamin-containing blend or dough, a prolamin (preferably in powder form) is mixed with a solvent component to form a first mixture. Then an incorporation component (a non-prolamin protein powder and/or a starch) is mixed with the first mixture to form a second mixture. Water and a fat component are mixed with the second mixture to form a prolamin-containing blend or prolamin-containing dough. The inclusion of the incorporation component has surprisingly been found to enable the prolamin to be incorporated into the oil and water of the prolamin-containing blend. Without the inclusion of the incorporation component, the prolamin will not incorporate into the fat component and water and no blend or dough will be formed.

Any suitable prolamin ingredient may be used in the blend. In some examples, the prolamin comprises one or more of zein, gliadin, hordein, secalin, kafirin, and avenin. In one example, the prolamin comprises zein. A prolamin ingredient of any protein concentration may be used. In some approaches, the prolamin ingredient can be in the form of an isolate or a concentrate, though the precise form of the prolamin is not believed to be particularly limited. Generally, protein isolates have a higher crude protein content than protein concentrates. In one aspect, the prolamin may be included in the form of an isolate. When the prolamin is included in the form of an isolate, a higher wt % of crude protein may be achieved in the blend for a given amount by weight of the isolate versus a concentrate, as well as minimize any deleterious effects (e.g., off flavors) due to any non-protein components of the protein isolate.

The amount of crude protein in a protein ingredient may depend on the form of the ingredient (e.g., whether the ingredient is in the form of an isolate, a concentrate, or a flour). Therefore, for purposes herein, the crude protein content is the amount of protein contributed by any protein-containing ingredient. The amount of crude protein in a protein ingredient or in the food product may be measured by the Association of Official Analytical Chemists (AOAC) Official Method 990.03 (which is incorporated herein by reference in its entirety). Additionally, or alternatively, the amount of crude protein in a protein ingredient or in the food product may be measured by the Dumas Method.

It has been unexpectedly found that a weight ratio of prolamin to solvent component of 0.66:1 to 1.25:1, in another aspect a ratio of 0.66:1 to 1.02:1, in another aspect a ratio of 0.67:1 to 1.18:1, in another aspect a ratio of 0.67:1 to 0:97:1, in another aspect a ratio of 0.68:1 to 1.11:1, in another aspect a ratio of 0.68:1 to 0.91:1, in another aspect a ratio of 0.80:1 to 1.25:1, in another aspect a ratio of 0.80:1 to 1.02:1, in another aspect a ratio of 0.82:1 to 1.18:1, in another aspect a ratio of 0.82:1 to 1:1, in another aspect a ratio of 0.82:1 to 0.97:1, in another aspect a ratio of 0.83:1 to 1.11:1, in another aspect a ratio of 0.83:1 to 0.91:1, is important so that the prolamin may be incorporated into the blend and so that the desired stretching characteristics may be achieved. When calculating the weight ratio of the prolamin to the solvent component, the weight of the prolamin is the weight of the crude protein in the prolamin. If too high of an amount of prolamin is used with too low of an amount of solvent component (i.e., a weight ratio of prolamin to the solvent component above 1.25:1), the food product may have (i) a thick, curdled, and/or non-homogenous texture, (ii) little or no stretching characteristics, and/or (iii) oiling off (i.e., oil separation). If too low of an amount of prolamin is used with too high of an amount of solvent component (i.e., a weight ratio of prolamin to the solvent component below 0.66:1), the resulting food product may have (i) have limited prolamin functionality (i.e., reduced or no stretch), (ii) a too sour taste (if the solvent component is an acid), and/or (ii) too low of a pH (if the solvent component is an acid).

In one approach, the prolamin is present in an amount within the range of about 4 wt % to about 20 wt % crude protein, in another about 4.1 wt % to about 20 wt % crude protein, in another about 6 wt % to about 18 wt % crude protein, in another about 6.1 wt % to 17.5 wt % crude protein, in another about 8 wt % to about 15 wt % crude protein, in another about 8.2 wt % to about 15 wt % crude protein, based on the total weight of the prolamin-containing blend.

In one approach, the solvent component is present in an amount within the range of about 4 wt % to about 25 wt %, in another aspect about 7 wt % to about 22 wt %, in another aspect about 9 wt % to about 18 wt %, based on the total weight of the blend.

For sake of simplicity and purposes herein, the term “solvent component” includes any prolamin solvent and/or any prolamin plasticizer. The term “solvent component” specifically encompasses prolamin plasticizers, even if those plasticizers are not solvents. Suitable solvent components include one or more of lactic acid, acetic acid, benzyl alcohol, glycerol, propionic acid, oleic acid, palmitic acid, myristic acid, stearic acid, and propylene glycol. In some examples, the solvent component may be a liquid acid. Additionally, or alternatively, the solvent component may include water (in addition to the prolamin solvent and/or prolamin plasticizer). As an example, the solvent component may be an acid solution (e.g., an 88% lactic acid solution). When the solvent component includes water, the solvent component may be present in an amount within the range of about 3.5 wt % to about 22 wt % crude solvent, in another aspect about 8 wt % to about 16 wt % crude solvent, based on the total weight of the blend. For purposes herein, the crude solvent content is the amount of prolamin solvent and/or prolamin plasticizer contributed by the solvent component. The solvent component is able to at least partially or completely dissolve and/or plasticize the prolamin. The solvent component may be considered to at least partially or completely plasticize the prolamin if it softens and increases the flexibility of the prolamin. For inclusion in dairy products or plant-based cheese analogs, lactic acid may be a preferred solvent component for flavor purposes. In some examples, the lactic acid may provide a characteristic dairy flavor to the plant-based food product.

The blend further includes an incorporation component that comprises one or more of a second non-prolamin protein and a starch. This incorporation component enables the prolamin to be incorporated into the blend. The second protein and/or the starch bind water and oil, which allows the prolamin to be and remain incorporated in the blend.

In one approach, incorporation component is present in an amount within the range of about 10 wt % to about 30 wt %, based on the total weight of the blend.

In some examples, the incorporation component includes the second non-prolamin protein. In addition to enabling the prolamin to be incorporated into the blend, the second protein may also provide protein content to the food product. The second protein may help a plant-based food product achieve a protein content similar to its non-plant-based analog (e.g., when the non-plant-based analog has a protein content). As an example, when the food product is a plant-based cheese product, the second protein may help the food product achieve a protein content similar to a dairy-based cheese. In one approach, a total amount of protein in the prolamin-containing blend is within the range of about 4 wt % to about 32 wt % crude protein, or about 11 wt % to about 24 wt % crude protein, based on a total weight of the prolamin-containing blend.

In some approaches, the second protein is a plant-based protein. For sake of simplicity and purposes herein, the term “plant-based protein” includes any non-dairy and non-animal-based proteins. The term “plant-based protein” also specifically encompasses fungus-based proteins or proteins produced via fermentation by microbes, even though those proteins are not of plant origin.

In one approach, the second protein is present in an amount within the range of 0 wt % to about 12 wt % crude protein, in another aspect about 1 wt % to about 12 wt % crude protein, in another aspect about 2 wt % to about 12 wt % crude protein, in another aspect about 3 wt % to about 9 wt % crude protein, based on the total weight of the blend.

Any suitably functional protein may be used in the blend. A protein may be considered to be suitably functional if it has a protein solubility index (PSI), water holding capacity (WHC), and/or emulsion capacity (EC) within the ranges listed below.

In some approaches, the second protein has a protein solubility index (PSI) of greater than 15%. The protein solubility index may be measured by preparing a dispersion in deionized water with 5% (w/w) of the protein and 1.5% (w/w) salt (NaCl) and adjusting, at 22° C., the pH of the dispersion to pH 4.5 using lactic acid or sodium hydroxide. After hydration overnight at 4° C. and readjustment of the pH to 4.5 (if necessary), the dispersion is centrifuged, and the protein content of the resulting supernatant is measured. The protein solubility index is expressed as a percentage of the original protein content of the protein ingredient that is in the supernatant.

In some approaches, the second protein has a water holding capacity (WHC) of at least 1.5 grams of water per 1 gram of solids of the second protein. Water holding capacity may be measured by preparing a dispersion in deionized water with 5% (w/w) of the protein and 1.5% (w/w) salt and adjusting, at 22° C., the pH of the dispersion to 4.5 using lactic acid or sodium hydroxide. After hydration overnight at 4° C. and readjustment of the pH to 4.5 (if necessary), the dispersion is centrifuged, and the supernatant is evaluated for solids. The pellet and supernatant weight are measured and the grams of water retained per gram of solids is calculated.

In some approaches, the second protein has an emulsion capacity (EC) of at least 165 mL oil per 100 milligrams of protein. Emulsion capacity may be measured by preparing a solution in deionized water with 0.015% (w/v) of the protein and adjusting, at 22° C., the pH of the solution to 4.5 using lactic acid or sodium hydroxide. An aliquot of the solution is added to blender equipped with an electrode placed such that it is in continuous contact with the solution during the blending operation. While blending, oil is added continuously at a rate of 1.5 mL/s. Emulsion formation and inversion is monitored by measuring resistance with a resistance meter with output to a computer. Inversion of the emulsion is defined as the point at which resistance spikes above 3 megaohms. This test is run in triplicate, and the amount of oil added is calculated by time and flow rate measurement. The average mL oil emulsified per 100 mg protein is the emulsifying capacity.

In some aspects, the plant-based protein comprises one or more of chickpea protein, faba protein (also referred to as fava protein), soy protein, mungbean protein, pea protein, potato protein, canola protein, lentil protein, lupin protein, flax protein, legume protein, almond protein, walnut protein, sunflower protein, quinoa protein, algae protein, and mycelia protein. In one aspect, the plant-based protein comprises one or more of chickpea protein, faba protein, canola protein, lentil protein, and flax protein. In another aspect, the plant-based protein comprises two or more chickpea protein, faba protein, mungbean protein, pea protein, potato protein, canola protein, lentil protein, lupin protein, flax protein, sunflower protein, and quinoa protein. In still another aspect, the plant-based protein comprises chickpea protein. In some approaches, the plant-based protein can be in the form of an isolate, a concentrate, or a flour, though the precise form of the plant-based protein is not believed to be particularly limited. In one aspect, the plant-based protein may be in the form of an isolate. In some approaches, the plant-based protein is in the form of an isolate or a concentrate that contributes to emulsification of the plant-based food product.

In some examples, the incorporation component includes a starch. The starch, either alone or in combination with the plant-based protein, binds water and oil, which enables the prolamin to be and remain incorporated in the blend. Any suitable starch may be used. In some examples, the starch may be an emulsifying starch. In some examples, the starch may be an octenyl succinic anhydride (OSA) starch. Examples of suitable starches include, for example, ACCUBIND® starch (Cargill) or STA-MIST® starch (Tate & Lyle), which are both OSA-modified dent corn starches. In one approach, the starch is present in an amount within the range of 0 wt % to about 20 wt %, in another aspect about 1 wt % to about 20 wt %, in another aspect about 2 wt % to about 20 wt %, in another aspect about 5 wt % to about 20 wt %, in another aspect about 5 wt % to about 15 wt %, in another aspect about 7 wt % to about 15 wt % based on the total weight of the blend.

The blend further includes a fat component. Any suitable fat component may be used in the blend. In some aspects, the fat component comprises one or more of coconut oil, palm oil, palm oil fraction, shea butter, shea olein, shea oil, shea stearin, sunflower oil, cocoa butter, soybean oil, canola oil, and cottonseed oil. In one aspect, the fat comprises coconut oil.

In some approaches, the fat component is in the form of one or more solid fats, one or more liquid oils, or a combination of one or more solid fats and one or more liquid oils. As used herein, solid fats refer to fats that are solid at room temperature (20° C.), and liquid oils refer to fats that are in liquid form at room temperature (20° C.).

In one approach, the fat component is present in an amount within the range of about 10 wt % to about 35 wt %, in another aspect about 15 wt % to about 30 wt %, based on the total weight of the prolamin-containing blend.

The blend further includes water. In some aspects, water is present in an amount within the range of about 20 wt % to about 35 wt %, in another aspect about 25 wt % to about 35 wt %, in another aspect about 26 wt % to about 30 wt %, in another aspect about 28 wt % to about 30 wt %, based on the total weight of the blend.

It has been unexpectedly found that prolamins may be incorporated into a food product via the blend to impart desirable stretch characteristics to the food product. When prepared according to the method described herein, the blend (including a prolamin, a solvent component, a non-prolamin second protein and/or a starch, a fat component, and water) has a stretchy, dough-like texture, and incorporating the blend into a food product imparts stretching characteristics to the food product. Accordingly, the prolamin-containing blend can be incorporated into processes for making food products. In one particular approach, it has been found to be advantageous to incorporate the prolamin-containing blend into cheese-making processes, including processes for making plant-based cheese products.

In one particular approach, the food product containing the prolamin-containing blend is a plant-based cheese product. When the plant-based food product is a plant-based cheese product, the plant-based cheese product has stretching characteristics similar to a dairy-based cheese. The dairy proteins in dairy-based cheese create a network and structure that results in the stretching characteristics of the dairy-based cheese. As the plant-based cheese product disclosed herein may be free of dairy proteins, dairy proteins cannot be relied upon to produce the desired stretching characteristics, including stretchability at conventional cooking temperatures. Rather, it has been unexpectedly found that a plant-based cheese product with characteristics consistent with consumer expectations for a dairy-based cheese could be obtained through use of a blend of a prolamin, a solvent component, a second non-prolamin protein and/or a starch, a fat component, and water.

Provided herein are plant-based cheese products comprising a prolamin-containing blend that comprises a prolamin, a solvent component, a second protein, wherein the plant-based protein is a non-prolamin protein, a fat component, and water, wherein a weight ratio of the prolamin to the solvent component is within the range of 0.66:1 to 1.25:1, and wherein the prolamin is incorporated into the prolamin-containing blend. In some aspects, the prolamin is smoothly, evenly, and/or completely incorporated into the prolamin-containing blend. In some other aspects, the prolamin is homogenously incorporated into the prolamin-containing blend.

In one approach, the prolamin-containing blend may be included or incorporated into a plant-based cheese product in a relatively small amount while still being effective to provide stretch characteristics to the plant-based cheese product. For example, the prolamin-containing blend may be included in an amount within the range of about 5 wt % to about 25 wt %, in another aspect about 5 wt % to about 20 wt %, in another aspect about 5 wt % to about 15 wt %, in another aspect about 10 wt % to about 15 wt %, based on the total weight of the plant-based cheese product.

The plant-based food products have prolamin incorporated therein in the form of the prolamin-containing blend. A food product may be considered to have prolamin incorporated therein when the prolamin and the other ingredients (e.g., water, fat, etc.) of the food product are combined into one cohesive substance.

The plant-based cheese product may be formed into desirable shape. In some examples, the plant-based cheese product is in the form of a cheese block, a sliced cheese, a diced cheese, or a shredded cheese.

The plant-based cheese product may be provided in a variety of flavors, such as American, Swiss, gouda, provolone, cheddar, Colby, Colby-jack, pepper-jack, or mozzarella. Flavoring agents may be added to achieve the desired flavor profile. Colors may also be added to achieve the desired color to the plant-based cheese product.

In another approach, inclusions may be added to achieve the desired flavor profile. For example, herbs, spices, peppers, chilies, garlic, natural or artificial flavors, and the like, alone or in combination, may be added to provide a desired flavor profile.

In one particular approach, the prolamin-containing blend may be incorporated into a method for making a plant-based cheese product that is in the form of an oil-in-water emulsion. In one approach, the prolamin-containing blend can be added at any appropriate step of the cheese-making process that enables the stretch characteristic to be maintained in the final product.

For example, a plant-based cheese-making process may include: preparing a prolamin-containing blend; preparing a starch slurry by combining water with two or more starches; combining a plant-based protein and melted fat to form a first mixture and heating the first mixture to about 71° C. to about 102° C.; adding the prolamin-containing blend to the heated mixture to form a second mixture; mixing the second mixture to form a homogenous mixture; heating second mixture to about 71° C. to about 102° C.; adding the starch slurry to the heated second mixture to form a third mixture and heating the third mixture to about 71° C. to about 102° C.; and cooling the heated third mixture to form the plant-based cheese product.

In one approach, the method for making the plant-based cheese includes combining a fat component with water, a protein, the prolamin-containing blend, and at least two starches to form a combination, wherein the first starch is a hydrophobic starch, the second starch is a modified starch, and the additional fat has a solid fat content in the range of 30% to about 60% at 50° F. and 0% to about 10% at 92° F. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. The ingredients may be blended while heating, if desired. Further, the ingredients may be held at the increased temperature for a time effective to pasteurize the mixture, such as with continued mixing. The mixture may be heated via steam injection or other means.

In another approach, the fat component may be melted, such as in a cooker, before the other ingredients are added, as described above.

In another approach, the plant-based food product can be made by the method comprising forming the prolamin-containing blend; melting a fat component; and adding a protein, the prolamin-containing blend, and water (and optionally a flexibility enhancing agent) to the melted fat to provide a first mixture. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. At least a first starch and a second starch are combined with water and then added to the heated mixture, wherein the first starch is a hydrophobic starch, and the second starch is a modified starch, to provide a second mixture. The second mixture is then held at the heated temperature for at the increased temperature for a time effective to pasteurize the mixture, such as with continued mixing if desired.

In another aspect, any of the approaches described herein may further comprise cooling the heated mixture to form the plant-based food product. In some examples, the plant-based food product is cooled to refrigeration temperatures (e.g., 1° C. to 5° C.). In another aspect, the cooling step may be accomplished on a chill belt.

In another aspect, any of the approaches described herein may further comprise adding an acidulant to the other ingredients. In one approach, the acidulant is added in an amount effective to provide a pH in the range of about 4.4 to about 5.7, in another aspect a pH of about 4.7 to about 5.5, in another aspect about 4.8 to about 5.3, and in another aspect about 4.8 to about 5.0, in the final plant-based food product. The inclusion of the acidulant to a provide a pH in the described ranges contributes to microbial stability of the product as well as providing desirable flavor.

In another aspect, any of the approaches described herein may further comprise filling the heated mixture into one or more containers prior to the cooling step.

In the described process, preparing the starch slurry comprises combining about 40 wt % to about 55 wt %, in another aspect about 46 wt % to about 50 wt %, of two or more starches with about 45 wt % to about 60 wt, in another aspect about 50 wt % to about 54 wt %, water. The plant-based cheese products include a combination of at least two starches to achieve the desired characteristics. The plant-based cheese product includes at least a first starch and a second starch. The combination of the first starch and the second starch can provide the plant-based cheese product a desirable firm texture at refrigeration temperatures and desirable melt characteristics at cooking temperatures.

In one aspect, the first starch is a hydrophobic starch. The hydrophobic starch may act as an emulsifier during the manufacturing process and in the plant-based cheese product. The hydrophobic starch may also provide water management to the plant-based cheese product.

Any suitable hydrophobic starch may be used. In some examples, the hydrophobic starch may be an octenyl succinic anhydride (OSA) starch. Examples of suitable hydrophobic starches include, for example, ACCUBIND® starch (Cargill) or STA-MIST® starch (Tate & Lyle), which are both OSA-modified dent corn starches. It is presently believed that the hydrophobic starch acts as an emulsifier.

In one approach, the hydrophobic starch is present in an amount within the range of about 0.5 wt % to about 15 wt %, about 1 wt % to about 13 wt %, in another aspect about 5 wt % to about 15 wt %, about 7 wt % to about 13 wt %, about 8 wt % to about 11 wt %, or about 8 wt % to about 10 wt %, based on a total weight of the plant-based cheese product.

The second starch is a modified starch different from the first, hydrophobic starch. In one approach, any suitable modified waxy starch may be used. In some examples, the modified waxy starch may be a waxy (non-amylose containing starch) starch that is crosslinked, substituted, or both crosslinked and substituted. The modified waxy starch is selected to provide viscosity and water management when the cheese product is at elevated temperature, either during the manufacturing process or upon heating by the consumer. The modified waxy starch may be referred to as a water-managing starch. For instance, the modified starch may be REZISTA® starch (Tate & Lyle) and/or SHUR-FIL® 677 modified starch (Tate & Lyle). The SHUR-FIL® 677 modified starch can provide thickening effect at elevated temperatures, such as between 100 to 150° F.

In another approach, the modified starch may further comprise a modified starch such as a dent corn starch that forms a thermoreversible gel. This additional starch may also be selected from hydrolyzed, amylose-containing starches. In one exemplary approach, the starch may be an acid-thinned starch. The additional starch may be a gelling starch. For instance, the acid-thinned or gelling starch may be THINGUM® starch (Tate & Lyle). The hydrolyzed, amylose-containing starch is selected to provide firmness upon cooling, a low hot viscosity, and sliceability to the plant-based cheese product.

At least in some embodiments, it has been found advantageous that a combination of modified starches be included (i.e., both a modified waxy starch (water-managing starch) and a hydrolyzed, amylose-containing starch (gelling starch)) along with the first hydrophobic starch. The relative amounts of the modified starches are selected to provide the desired properties in the cheese product. The combination of second starches can provide desirable physical properties at both hot and cold temperatures (such as firmness upon cooling and desirable viscosity at elevated temperatures), thereby better replicating the properties of dairy-based cheeses and meeting consumer expectations.

In one approach, the second starch, which may include a combination of modified starches, is present in an amount within the range of about 0.5 to about 15 wt %, about 1.5 wt % to about 14 wt %, about 2 wt % to about 12 wt %, about 2 wt % to about 10 wt %, based on a total weight of the plant-based cheese product. The ranges here are applicable to modified waxy starch and hydrolyzed amylose-containing starch included individually, or to a combination of modified waxy starch and hydrolyzed amylose-containing starch.

In one approach, the water-managing starch is present in an amount within the range of about 1 to about 12 wt %, about 1.5 wt % to about 10 wt %, or about 2 wt % to about 9 wt %, based on a total weight of the plant-based cheese product. The ranges here are applicable to one or more modified waxy starches. For plant-based cheese products having an amount of protein from 2 wt % to less than 6 wt % crude protein, the water-managing starch may be included in an amount such as about 4 to about 12 wt %, about 4 wt % to about 10 wt %, or about 5 wt % to about 9 wt %, based on a total weight of the plant-based cheese product. For plant-based cheese products having a higher amount of protein, such as 6% or more crude protein, generally less water-managing starch may be included, such as about 1 to about 8 wt %, about 1.5 wt % to about 6 wt %, or about 2 wt % to about 5 wt %, based on a total weight of the plant-based cheese product.

In one approach, the gelling starch is present in an amount within the range of about 0.25 wt % to about 4 wt %, about 0.5 wt % to about 3 wt %, about 0.5 wt % to about 2 wt %, or about 0.75 wt % to about 1.5 wt %, based on a total weight of the plant-based cheese product. The ranges here are applicable to one or more modified waxy starches.

In one approach, the modified waxy starch and hydrolyzed amylose-containing starches may be included in a ratio of about 10:1 to about 1:10, and in another aspect about 5:1 to about 1:5, and in another aspect about 3:1 to about 1:3.

In one approach, the method for preparing the prolamin-containing blend includes: mixing a prolamin and solvent component to form a first mixture, wherein a weight ratio of the prolamin to the solvent component is within the range of 0.66:1 to 1.25:1; adding a plant-based protein and/or a starch to the first mixture to form a second mixture, wherein the plant-based protein is a non-prolamin protein; adding a fat component and water to the second mixture to form a prolamin-containing blend, wherein the prolamin is incorporated into the prolamin-containing blend.

The method may include mixing the prolamin and solvent component to form a first mixture. In some examples, the prolamin and solvent component may be mixed to form a homogenous, first mixture. In one approach, at least a portion of the prolamin is plasticized and/or dissolved in the solvent component.

The method may further include adding a plant-based protein and/or a starch to the first mixture to form a second mixture. In some examples, the plant-based protein and/or a starch, and first mixture may be mixed to form the second mixture. In some of these examples, the plant-based protein and/or a starch, and first mixture may be mixed to form a homogenous, second mixture.

The addition of the plant-based protein and/or a starch enables the fat component and water to be incorporated into the second mixture to form the prolamin-containing blend. Without the addition of the plant-based protein and/or a starch, the prolamin is not able to be incorporated into the fat component and water.

The method may further include adding a fat component and water to the second mixture to form a prolamin-containing blend. In some examples, the fat component, water, and the second mixture may be mixed to form the prolamin-containing blend. In some of these examples, the fat component, water, and the second mixture may be mixed to form a homogenous prolamin-containing blend.

In one approach, the plant-based cheese product includes: a plant-based protein; at least a first and second starch, the first starch comprising a hydrophobic starch and the second starch comprising a modified starch; optionally a flexibility enhancing agent; a fat component having a solid fat content in the range of 30% to about 60% at 50° F. and about 0% to about 10% at 92° F.; and an acidulant in an amount effective to provide a pH of the plant-based cheese product of about 4.5 to about 5.7.

In another approach, the plant-based-cheese product may include two modified starches, including a water-managing starch and a gelling starch, in addition to the hydrophobic starch. In one aspect, the plant-based protein is chickpea protein, which provides hot viscosity and emulsification. The combination of starches provides a significant amount of emulsification, hot viscosity, and cold texture. The resulting plant-based cheese product is sliceable at cold temperatures and also has desirable melt characteristics at cooking temperatures.

The plant-based cheese product includes a plant-based protein. Any suitable plant-based protein may be used in the plant-based cheese product. In some embodiments, the plant-based protein comprises one or more of chickpea protein, fava protein, soy protein, mung bean protein, pea protein, canola protein, and lentil protein. In some approaches, the plant-based protein can be in the form of an isolate, a concentrate, or a flour, though the precise form of the plant-based protein is not believed to be particularly limited. In one embodiment, the plant-based protein comprises chickpea protein. In some examples, the fungus protein comprises mycoprotein.

As noted above, the plant-based protein may also be of microbial origin. For example, proteins commonly of dairy-based origin, such as casein or whey, may be obtained via microbial fermentation. If produced by a microorganism using a non-dairy based substrate and fermentation medium, the resulting protein would be considered a plant-based protein for purposes herein.

In some embodiments, the plant-based protein is the only source of protein in the plant-based cheese product. In this respect, in some embodiments, the plant-based cheese product includes no animal proteins, including, for example, casein and whey. Additionally, or alternatively, the product may be a vegan cheese product (i.e., there are no ingredients of animal origin of any kind in the cheese product).

In one approach, the plant-based protein is present in an amount within the range of about 1 wt % to about 20 wt % crude protein, in another aspect about 1 wt % to about 20 wt % crude protein, in another aspect about 3 wt % to about 12 wt % crude protein, in another aspect about 5 wt % to about 9 wt % crude protein, based on a total weight of the plant-based cheese product. In another approach, the plant-based protein is present in an amount within the range of about 2 wt % to about 20 wt % crude protein, about 2 wt % to about 15 wt % crude protein, about 4 wt % to about 15 wt % crude protein, or about 4 wt % to about 10 wt % crude protein based on a total weight of the plant-based cheese product. In one approach, the plant-based protein may be included in an amount of 2 wt % to less than 6 wt % crude protein, 2.5 wt % to 5.5 wt % crude protein, or 3 wt % to 5 wt % crude protein based on a total weight of the plant-based cheese product. Other types of plant-based cheese products may have a higher amount of plant-based protein, such as 6 wt % crude protein or more, 6 wt % to 10 wt % crude protein, 6.5 wt % to 9.5 wt % crude protein, or 7 wt % to 9 wt % crude protein based on a total weight of the plant-based cheese product.

The amount of crude protein in a plant-based protein ingredient may depend on the form of the ingredient (e.g., whether the ingredient is in the form of an isolate, a concentrate, or a flour). Therefore, for purposes herein, plant-based protein refers to the crude protein content, i.e., the amount of protein contributed by the ingredient that delivers the plant-based protein. For instance, the commercially available ARTESA® chickpea protein product includes about 60% protein and 40% non-protein components. If a plant-based cheese product includes about 13 wt % ARTESA® chickpea protein product, the plant-based cheese product will include about 8 wt % plant-based protein, for percentage purposes herein. The amount of crude protein in a plant-based protein ingredient or in the plant-based cheese product may be measured by the Association of Official Analytical Chemists (AOAC) Official Method 990.03 (which is incorporated herein by reference in its entirety). Additionally, or alternatively, the amount of crude protein in a plant-based protein ingredient or in the plant-based cheese product may be measured by the Dumas Method.

In some approaches, it has been found to be advantageous that the plant-based protein have a small mean particle size to allow for good dispersion of the protein within the fat component. For example, use of a plant-based protein having a mean particle size below about 15 microns may be beneficial. In another aspect, use of a plant-based protein having a mean particle size in the range of about 6 to about 15 microns, in another aspect about 8 to about 11 microns, may be beneficial. In some examples, the mean particle size of the protein may be determined using dynamic light scattering. As an example, a Zetasizer Ultra-DLS (Malvern) may be used to measure the mean particle size using dynamic light scattering.

In some approaches, the inclusion of chickpea protein, and with the small mean particle size described herein, has surprisingly been found to provide significant benefits to the “oiling off” problem that can occur with dairy-based cheese products when not stored at refrigerated temperatures. Oiling off refers to the separation of oil from the other ingredients, resulting in a product that exudes oil during production, at room temperature, or when heated.

In some approaches, the plant-based protein in the prolamin-containing blend that is a non-prolamin protein may be the same or different as the additional protein in the plant-based cheese product. In one aspect, the prolamin, the plant-based protein in the prolamin-containing blend that is a non-prolamin protein, and the protein in the plant-based cheese product may be the only sources of protein in the plant-based food product. In this respect, in some aspects, the plant-based food product includes no animal proteins, including, for example, casein and whey. Additionally, or alternatively, the product may be a vegan food product (i.e., there are no ingredients of animal origin of any kind in the food product).

In some aspects, the plant-based food product includes no nut-based proteins, including, for example, one or more of almond protein, peanut protein, and cashew protein. Additionally, or alternatively, the plant-based food product may be free of one or more of oat protein, rice protein, wheat protein, and/or sunflower seeds.

In one approach, a total amount of protein in the plant-based cheese product, including the prolamin-containing blend, is within the range of about 3.2 wt % to about 20 wt % crude protein, about 5.4 wt % to about 12.6 wt % crude protein, or about 8 wt % to about 10 wt % crude protein, based on a total weight of the plant-based food product.

Water is also included in an amount of about 30 wt % to about 60 wt %, in another aspect about 37 wt % to about 55 wt %, in another aspect about 42 wt % to about 55 wt %, based on a total weight of the plant-based cheese product.

The plant-based cheese product may further include a flexibility enhancing agent, which results in decreased friability and/or rigidity of the cheese product. For example, the flexibility enhancing agent may act as a filler. Additionally, or alternatively, the flexibility enhancing agent may contribute to flexibility of the plant-based cheese product. The flexibility enhancing agent may be a polysaccharide, gum, or hydrocolloid. Suitable flexibility enhancing agents include, for example, one or more of instant starch, xanthan gum, guar gum, locust bean gum, cellulose gum, fenugreek gum, konjac gum, agar, gellan gum, propylene glycol alginate (PGA), alginate, microcrystalline cellulose (MCC), carboxymethyl cellulose (CMC), konjac glucomannan, carrageenan, and pectin. In some examples, the flexibility enhancing agent comprises one or more of carrageenan and pectin. It has been found that addition of a polysaccharide, gum, or hydrocolloid can further improve sliceability of the plant-based cheese product at cold temperatures (e.g., 5° C.).

In one approach, the flexibility enhancing agent is present in an amount within the range of about 0.05 wt % to about 5 wt %, in another aspect about 0.05 wt % to about 4 wt %, in another aspect about 0.05 to about 3 wt %, in another aspect about 0.05 wt % to about 2 wt %, in another aspect about 0.05 wt % to about 1 wt %, in another aspect about 0.05 wt % to about 0.5 wt %, and in another aspect about 0.1 wt % to about 0.3 wt %. In one particular approach, the flexibility enhancing agent is a hydrocolloid, such as carrageenan.

In another approach, the flexibility enhancing agent may be included about 0.1 wt % to about 20 wt %, based on a total weight of the plant-based cheese product. In another approach, the flexibility enhancing agent is present in an amount within the range of about 0.1 to about 15 wt %, about 0.1 to about 12 wt %, about 0.2 to about 12 wt %, about 1 wt % to about 15 wt %, about 1 wt % to about 12 wt %, about 2 wt % to about 10 wt %, about 2 wt % to about 5 wt %, or about 5 wt % to about 10 wt %, based on a total weight of the plant-based cheese product.

In another approach, the plant-based cheese product may be free of the flexibility enhancing agent.

The plant-based cheese product further includes a fat component having a solid fat content in the range of about 30% to about 60% at 50° F. and 0% to about 10% at 92° F. When the fat component has a solid fat content within the specified ranges, the fat component may act similarly to butter fat, which may contribute to the plant-based cheese product having a flavor profile, cold texture, and melt profile similar to a dairy-based cheese.

Any suitable fat component comprising one or more solid fats, liquid oils, or combination thereof having a solid fat content in the range of about 30% to about 60% at 50° F. and 0% to about 10% at 92° F. may be used. In some examples, the fat component comprises one or more of coconut oil, palm oil, palm oil fraction, shea butter, and shea olein. In some of these examples, the fat component further comprises one or more of soybean oil, sunflower oil, olive oil, canola oil, peanut oil, sesame oil, and corn oil to provide a blend of ingredients to provide the desired solid fat content at the respective temperatures. In other examples, the fat component comprises the coconut oil.

In one approach, the fat component is present in an amount within the range of about 15 to about 30 wt %, in another aspect about 20 wt % to about 30 wt %, based on a total weight of the plant-based cheese product.

In another aspect, any of the methods described herein may further comprise adding an acidulant to the first or second mixture. In one approach, the acidulant is added in an amount effective to provide a pH in the range of about 4.4 to about 5.7, in another aspect a pH of about 4.7 to about 5.5, in another aspect about 4.8 to about 5.3, and in another aspect about 4.8 to about 5.0, in the final plant-based cheese product. The acidulant may be any food grade acidulant, such as citric acid, lactic acid, or combination thereof. In one aspect, the acidulant is lactic acid, which can provide a characteristic dairy flavor to the plant-based cheese product. The inclusion of the acidulant to a provide a pH in the described ranges contributes to microbial stability of the product as well as providing desirable flavor.

In some aspects, when an acidulant is used as the solvent component, an additional acidulant may not be needed. In these aspects, the final plant-based cheese product may have a pH in the above listed ranges without adding an acidulant other than the solvent component in the prolamin-containing blend.

In some aspects, the plant-based food product further includes one or more of salt, an antimicrobial agent, a colorant, and a flavor. In some aspects, the plant-based food product further includes maltodextrin.

Antimicrobial agents may be added to the plant-based food product in order to enhance resistance to bacterial and mold growth, such as by addition of sorbic acid, cultured vinegar, cultured sugar, cultured dextrose. In some approaches, the antimicrobial agent may also be serving as an acidulant.

In addition to the hydrophobic starch, a chemical emulsifier may be included. Suitable chemical emulsifiers include, for example as orthophosphates (including disodium phosphates, monosodium phosphates, and trisodium phosphates), sodium hexametaphosphates, sodium acid pyrophosphates, trisodium citrate, polyoxyethylene sorbitan monostearate (polysorbate 60), or other emulsifiers or combinations of emulsifiers. In other approaches, no chemical emulsifiers are included.

In some examples, the plant-based cheese product may additionally include a flavor masking agent. Masking agents may include any suitable ingredient effective to lower a perceived intensity of a particular flavor. In some applications, consumers may perceive non-dairy proteins as contributing an off-flavor to a cheese-type product (i.e., a flavor inconsistent with consumer expectations for a dairy-based cheese). For example, soy is sometimes perceived as contributing an undesirable beany flavor to food products. To reduce the flavor of certain non-dairy proteins, it may be desirable to include a flavor masking agent. For example, agents may include sweeteners (including nutritive and non-nutritive sweeteners), flavors, bitter blockers, or other suitable additive. Any suitable amount may be included. In one particular approach, the agent may be effective to bind to the off-flavors, thereby reducing or preventing the perception of the flavor. Suitable flavor binders include, for example, thaumatin and neohesperidin dihydrochalcone (NHDC), which may also be categorized as sweeteners, and generally are included in an amount within the range of greater than 0 wt % to about 0.005 wt %, based on a total weight of the plant-based food product.

In some aspects, the plant-based food product may be free from one or more of nut-based proteins, almond protein, peanut protein, cashew protein, oat protein, rice protein, wheat protein, sunflower seeds, non-plant-based protein or non-starch emulsifiers, lecithin, monoglycerides, diglycerides, polyethylene glycol, propylene glycol alginate, polysorbate, palm oil, and palm oil fraction.

In another aspect, any of the methods described herein may further comprise combining the plant-based protein with a flavor masking agent and water prior to combining the plant-based protein with other ingredients of the plant-based cheese product.

In another aspect, any of the methods described herein may further comprise adding one or more of salt, a preservative, colorant, and flavor. Particulates or inclusions (e.g., herbs, spices, pepper pieces) may also be added with any of the methods described herein.

The methods described herein may also further comprise cutting the plant-based cheese product into various shapes and sizes, such as blocks, slices, cubes, shreds, and the like.

The plant-based cheese products may be cooked and processed using any conventional equipment, including the use of a laydown cooker, kettle, or other device. Shredding and packaging may also be accomplished with conventional equipment.

In another aspect, any of the methods described herein may further comprise filling the heated mixture into one or more containers prior to the cooling step. In another aspect, the cooling step may be accomplished on a chill belt.

The final plant-based cheese mixture may be filled into any appropriate container and allowed to cool. In one aspect, the final mixture is filled into a box and allowed to cool to form a block of the plant-based cheese product. The plant-based cheese product disclosed herein may formed into desirable shape. In some examples, the plant-based cheese product is in the form of a cheese block, a sliced cheese, a diced cheese, or a shredded cheese. In some approaches, the plant-based cheese product may be in the form of an oil-in-water emulsion. In some approaches, the plant-based cheese product may be in the form of an oil-in-water emulsion that is solidified in the form of a cheese block, a sliced cheese, a diced cheese, or a shredded cheese at a temperature of 3-5° C.

To further illustrate the present disclosure, examples are given herein. It is to be understood that these examples are provided for illustrative purposes and are not to be construed as limiting the scope of the present disclosure.

### EXAMPLES

### Example 1

An example plant-based food product (referred to as “Ex. Blend 1”) was prepared. A comparative example plant-based food product (referred to as “Comp. Ex. Blend 1”) was also prepared. Both Ex. Blend 1 and Comp. Ex. Blend 1 included zein protein (FloZein™ zein protein isolate obtained from FloZein Products, about 82-100% crude protein by weight of the isolate), lactic acid, coconut oil, and water. Ex. Blend 1 also included chickpea protein (ARTESA® chickpea protein concentrate obtained from Nutriati, about 60% crude protein by weight of the concentrate), and Comp. Ex. Blend 1 did not include a protein other than the zein protein.

Ex. Blend 1 and Comp. Ex. Blend 1 were prepared using the formulations shown in Table 1, with the wt % of each ingredient that was used (based on the total weight of the plant-based food product).

TABLE 1

| | Ex. | Comp. Ex. |
|---|---|---|
| | Blend 1 | Blend 1 |
| Ingredient | (wt %) | (wt %) |
| Zein Protein* | 14.28 | 16.67 |
| Lactic Acid** | 14.28 | 16.67 |
| Chickpea Protein† | 14.28 | — |
| Coconut Oil | 28.58 | 33.33 |
| Water | 28.58 | 33.33 |
| Total | 100.00 | 100.00 |

*FloZein ™ (FloZein Products)
**88%, fermented
†ARTESA ® (Nutriati)

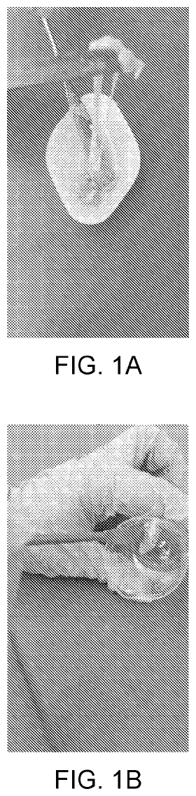

To prepare Ex. Blend 1, the zein protein and lactic acid were mixed together. Then, the chickpea protein was mixed with the zein protein and lactic acid mixture. The water was added and mixed in, and then, the coconut oil was added and mixed in. Both the water and the coconut oil were able to be incorporated into the zein protein, lactic acid, and chickpea protein mixture. After the water and the coconut oil were incorporated into the mixture a stretchy, dough-like substance was formed. FIG. 1A shows the stretchy, dough-like substance that was formed (i.e., Ex. Blend 1).

To prepare Comp. Ex. Blend 1, the zein protein and lactic acid were mixed together. The water was added and mixed with the zein protein and lactic acid mixture, and then, the coconut oil was added and mixed with the zein protein and lactic acid mixture. Neither the water nor the coconut oil was able to be incorporated into the zein protein and lactic acid mixture. FIG. 1B shows Comp. Ex. Blend 1 with the water and the coconut oil unable to be incorporated into the zein protein and lactic acid mixture.

### Example 2

Another example plant-based food product (referred to as “Ex. Slice 1”) was prepared. Another comparative example plant-based food product (referred to as “Comp. Ex. Slice 1”) was also prepared. Both Ex. Slice 1 and Comp. Ex. Slice 1 were prepared as plant-based cheese products, and both Ex. Slice 1 and Comp. Ex. Slice 1 included hydrophobic starch (ACCUBIND® starch obtained from Cargill), modified starch (REZISTA® starch obtained from Tate & Lyle), chickpea protein (ARTESA® chickpea protein concentrate obtained from Nutriati, about 60% crude protein by weight of the concentrate), coconut oil, and water. Ex. Slice 1 also included Ex. Blend 1 (form Example 1), and Comp. Ex. Slice 1 did not include zein protein or a blend, instead, the blend was replaced with additional chickpea protein, additional coconut oil, lactic acid, and additional water.

Ex. Slice 1 and Comp. Ex. Slice 1 were prepared using the formulations shown in Table 2, with the wt % of each ingredient that was used (based on the total weight of the plant-based food product).

TABLE 2

| | Ex. | Comp. Ex. |
|---|---|---|
| | Slice 1 | Slice 1 |
| Ingredient | (wt %) | (wt %) |
| Ex. Blend 1 | 0.70 | — |
| Salt | 1.68 | 1.68 |
| Sorbic Acid | 0.18 | 0.18 |
| Modified Starch†† | 1.98 | 1.98 |
| Hydrophobic Starch‡ | 8.92 | 8.92 |
| Starch Water | 10.90 | 10.90 |
| Maltodextrin‡‡ | 5.22 | 5.22 |
| Chickpea Protein† | 13.01 | 13.21 |
| Coconut Oil | 22.14 | 22.34 |
| Water | 32.76 | 32.96 |
| Lactic Acid** | — | 0.10 |
| Flavors | 2.51 | 2.51 |
| Total | 100.00 | 100.00 |

††REZISTA ® starch (Tate & Lyle)
‡ACCUBIND ® starch (Cargill)
‡‡STAR-DRI ® 10 (Tate & Lyle)
†ARTESA ® (Nutriati)
**88%, fermented

To prepare Ex. Slice 1, Ex. Blend 1 was prepared as described above in Example 1. A starch slurry was prepared by combining the starch water (i.e., water to be used in the starch slurry) with the modified starch and the hydrophobic starch. Water, salt, sorbic acid, flavors, chickpea protein, maltodextrin, and coconut oil were added to a Thermomix® TM6™ thermomixer, and the thermomixer was heated to 185° F., while the mixing speed was gradually increased from 0.5 to 3.0 to create a vortex. Then, the mixing was stopped, and the sides of the thermomixer were scraped down. Ex. Blend 1 was added to the thermomixer, the thermomixer was heated to 185° F., while mixing at a speed of 3.0, and held at 185° F. for 2 to 5 minutes until a homogenous mixture was formed. If sloshing occurred in the thermomixer, the mixture was transferred to a Silverson LAR Laboratory Mixer (scraping the sides and bottom of the thermomixer) and mixed at a mixing speed of 8 for 2 minutes, before transferring the mixture back to the thermomixer. After the homogenous mixture was formed, the thermomixer was heated to 185° F., while mixing at a speed of 3.0. The starch slurry was added to the thermomixer, and the thermomixer was heated to 185° F., while mixing at a speed of 3.0. Then, the mixing was stopped, and the sides of the thermomixer were scraped. Then, the thermomixer was held at 185° F. for 2 minutes. Then, the heated mixture was filled into a box and allowed to cool to form a block of the plant-based cheese product. Slices were cut from the block.

To prepare Comp. Ex. Slice 1, a starch slurry was prepared by combining the starch water (i.e., water to be used in the starch slurry) with the modified starch and the hydrophobic starch. The process water, salt, sorbic acid, flavors, maltodextrin, chickpea protein, coconut oil, and lactic acid were added to a Thermomix® TM6™ thermomixer, and heated and mixed as described above in reference to Ex. Slice 1 (except that Ex. Blend 1 was not added). The starch slurry was added and mixed into the other ingredients as described above in reference to Ex. Slice 1. Then, the heated mixture was filled into a box and allowed to cool to form a block of the plant-based cheese product. Slices were cut from the block.

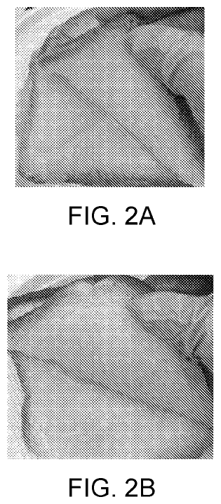

For each of Ex. Slice 1 and Comp. Ex. Slice 1, a slice of the plant-based cheese product was placed between two slices of bread and grilled to produce a grilled cheese type product. The slice of each of Ex. Slice 1 and Comp. Ex. Slice 1 melted but did not exhibit stretching. The grilled cheese type product with Ex. Slice 1 melted therein is shown in FIG. 2A, and the grilled cheese type product with Comp. Ex. Slice 1 melted therein is shown in FIG. 2B.

### Example 3

Additional plant-based food products (referred to as “Ex. Blend A,” “Ex. Blend B,” “Ex. Blend C,” “Ex. Blend D,” “Ex. Blend E,” “Ex. Blend F,” “Ex. Blend G,” “Ex. Blend H,” “Comp. Ex. Blend I,” and “Ex. Blend J”) were prepared. Each of the plant-based food products included zein protein (FloZein™ zein protein isolate obtained from FloZein Products, about 82-100% crude protein by weight of the isolate), lactic acid, either coconut oil or sunflower oil, and water. Each of the example plant-based food products except for Ex. Blend C also included chickpea protein (ARTESA® chickpea protein concentrate obtained from Nutriati, about 60% crude protein by weight of the concentrate). Ex. Blend C did not include a protein other than the zein protein, and instead included hydrophobic starch (ACCUBIND® starch obtained from Cargill). Some of the example plant-based food products also included hydrophobic starch (ACCUBIND® starch obtained from Cargill). Comp. Ex. Blend I also included chickpea protein (ARTESA® chickpea protein concentrate obtained from Nutriati, about 60% crude protein by weight of the concentrate) but included a weight ratio of zein protein to lactic acid of 12:1.

Each of the plant-based food products (Ex. Blend A through Ex. Blend J) was prepared using the formulations shown in Tables 3 and 4, with the wt % of each ingredient that was used (based on the total weight of the plant-based food product).

TABLE 3

| | Ex. | Ex. | Ex. | Ex. | Ex. |
|---|---|---|---|---|---|
| | Blend A | Blend B | Blend C | Blend D | Blend E |
| Ingredient | (wt %) | (wt %) | (wt %) | (wt %) | (wt %) |
| Zein Protein* | 14.28 | 14.28 | 14.28 | 14.28 | 14.28 |
| Lactic Acid** | 14.28 | 14.28 | 14.28 | 14.28 | 14.28 |
| Chickpea Protein† | 14.28 | 7.14 | — | 7.14 | 3.57 |
| Hydrophobic Starch‡ | — | 7.14 | 14.28 | 7.14 | 10.72 |
| Coconut Oil | 28.58 | 28.58 | 28.58 | — | 28.58 |
| Sunflower Oil | — | — | — | 28.58 | — |
| Water | 28.58 | 28.58 | 28.58 | 28.58 | 28.57 |
| Total | 100.00 | 100.00 | 100.00 | 100.00 | 100.00 |

*FloZein ™ (FloZein Products)
**88%, fermented
†ARTESA ® (Nutriati)
‡ACCUBIND ® starch (Cargill)

TABLE 4

| | Ex. | Ex. | Ex. | Comp Ex. | Ex. |
|---|---|---|---|---|---|
| | Blend F | Blend G | Blend H | Blend I | Blend J |
| Ingredient | (wt %) | (wt %) | (wt %) | (wt %) | (wt %) |
| Zein Protein* | 14.29 | 17.14 | 17.14 | 30.00 | 18.81 |
| Lactic Acid** | 14.29 | 17.14 | 17.14 | 2.50 | 18.81 |
| Chickpea Protein† | 13.85 | 8.58 | 4.29 | 7.50 | 9.41 |
| Hydrophobic Starch‡ | 9.00 | 8.58 | 12.86 | 7.50 | 9.41 |
| Coconut Oil | 20.00 | 20.00 | 20.00 | 15.00 | 15.00 |
| Water | 28.57 | 28.56 | 28.57 | 37.50 | 28.56 |
| Total | 100.00 | 100.00 | 100.00 | 100.00 | 100.00 |

*FloZein ™(FloZein Products)
**88%, fermented
†ARTESA ® (Nutriati)
‡ACCUBIND ® starch (Cargill)

To prepare each of the plant-based food products the zein protein and lactic acid were mixed together. Then, the chickpea protein and/or hydrophobic starch (as applicable) was mixed with the zein protein and lactic acid mixture. The water was added and mixed in, and then, the coconut oil or sunflower oil (as applicable) was added and mixed in. Then, for each of the plant-based food products, the mixture was heated to 185° F. and held at 185° F. for 2 minutes, while mixing at a speed of 1.0-2.0 in a Thermomix® TM6™ thermomixer.

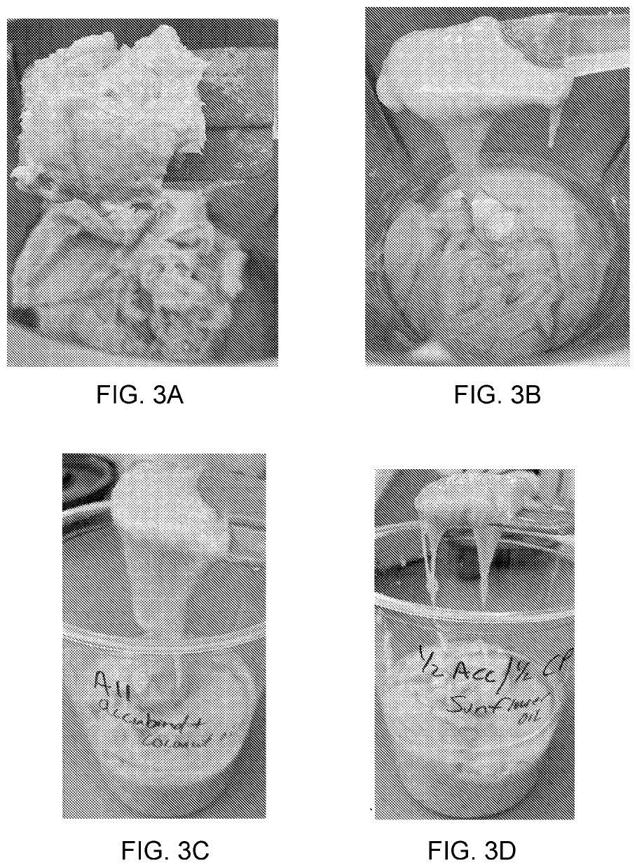

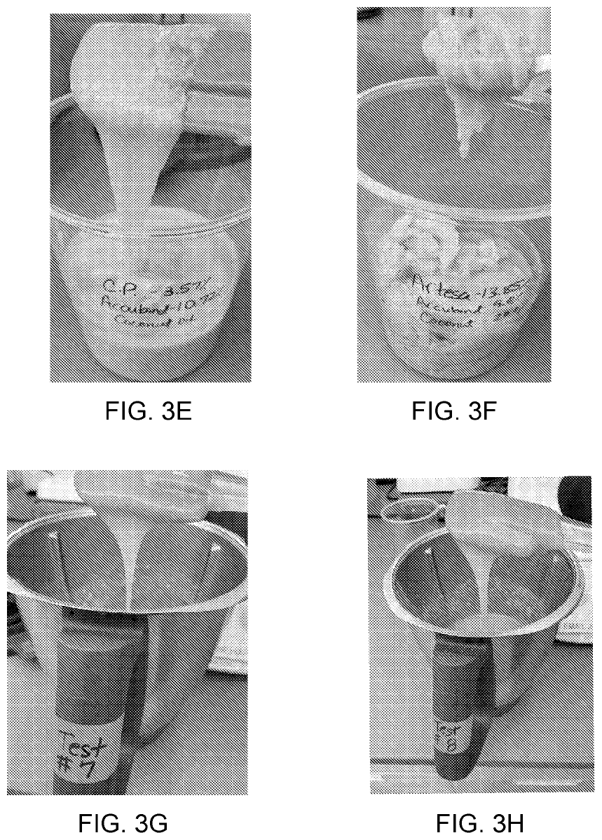

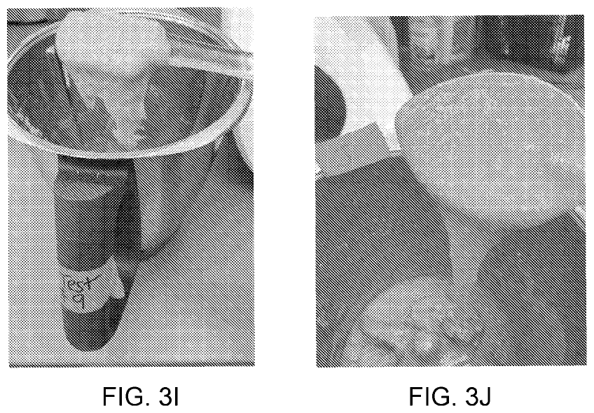

As Ex. Blend A was heated, the coconut oil melted and separated from the mixture. This separation was observed as soon as the mixture reached 150° F. Ex. Blend A is shown in FIG. 3A.

Ex. Blend C (all chickpea protein replaced with hydrophobic starch) was liquidy after processing but pulled together after sitting. Over a third of the oil was drained from Ex. Blend C. Ex. Blend C is shown in FIG. 3C.

Each of Ex. Blend B (hydrophobic starch added), Ex. Blend D (50/50 hydrophobic starch and chickpea protein, with sunflower oil), Ex. Blend E (75/25 hydrophobic starch and chickpea protein) successfully retained its stretching characteristics after processing but exhibited some oiling off (i.e., oil separation). Ex. Blend B is shown in FIG. 3B. Ex. Blend D is shown in FIG. 3D, and Ex. Blend E is shown in FIG. 3E.

Ex. Blend F (reduced oil) exhibited some oiling off (i.e., oil separation) and became more cohesive and less stretchy. Ex. Blend F is shown in FIG. 3F.

Ex. Blend G (reduced oil, with 50/50 hydrophobic starch and chickpea protein) was very smooth, had very little oiling off (i.e., oil separation), and great stretch. Ex. Blend G is shown in FIG. 3G. Ex. Blend G was considered a particularly beneficial formulation.

Ex. Blend H (reduced oil, with 75/25 hydrophobic starch and chickpea protein) had very little oiling off (i.e., oil separation) and great stretch, but was not as smooth as Ex. Blend G. Ex. Blend H is shown in FIG. 3H.

Comp. Ex. Blend I (zein protein to lactic acid weight ratio of 12:1) was very thick with little stretch and had oiling off (i.e., oil separation). Comp. Ex. Blend I also had a non-smooth texture with unincorporated zein. Comp. Ex. Blend I is shown in FIG. 3I.

Ex. Blend J (further reduced oil, with 50/50 hydrophobic starch and chickpea protein) had very little oiling off (i.e., oil separation) and great stretch, but did not have a smooth texture. Ex. Blend J also had a high solids percent and was clumpy. Ex. Blend J is shown in FIG. 3J.

### Example 4

Additional example plant-based food products (referred to as “Ex. Slice 5A,” “Ex. Slice 7A,” “Ex. Slice 7B,” “Ex. Slice 8A,” and “Ex. Slice 8B,”) were prepared. Each of the example plant-based food products were prepared as plant-based cheese products and included hydrophobic starch (ACCUBIND® starch obtained from Cargill), modified starch (REZISTA®) starch obtained from Tate & Lyle), chickpea protein (ARTESA® chickpea protein concentrate obtained from Nutriati, about 60% crude protein by weight of the concentrate), coconut oil, and water. Ex. Slice 5A also included Ex. Blend E (form Example 3). Ex. Slice 7A and Ex. Slice 7B also included Ex. Blend G (form Example 3). Ex. Slice 8A and Ex. Slice 8B also included Ex. Blend H (form Example 3).

Each of the example plant-based food products (Ex. Slice 5A, Ex. Slice 7A, Ex. Slice 7B, Ex. Slice 8A, and Ex. Slice 8B) was prepared using the formulations shown in Table 5, with the wt % of each ingredient that was used (based on the total weight of the plant-based food product).

TABLE 5

| | Ex. | Ex. | Ex. | Ex. | Ex. |
|---|---|---|---|---|---|
| | Slice 5A | Slice 7A | Slice 7B | Slice 8A | Slice 8B |
| Ingredient | (wt %) | (wt %) | (wt %) | (wt %) | (wt %) |
| Ex. Blend E | 10.00 | — | — | — | — |
| Ex. Blend G | — | 5.00 | 20.00 | — | — |
| Ex. Blend H | — | — | — | 5.00 | 12.00 |
| Salt | 1.73 | 1.73 | 1.73 | 1.73 | 1.73 |
| Sorbic Acid | 0.18 | 0.18 | 0.18 | 0.18 | 0.18 |
| Modified Starch†† | 2.03 | 2.03 | 2.03 | 2.03 | 2.03 |
| Hydrophobic Starch‡ | 8.08 | 8.72 | 7.43 | 8.50 | 7.60 |
| Starch Water | 11.18 | 11.18 | 11.18 | 11.18 | 11.18 |
| Maltodextrin‡‡ | 5.36 | 5.36 | 5.36 | 5.36 | 5.36 |
| Chickpea Protein† | 11.77 | 12.27 | 8.41 | 12.48 | 10.98 |
| Coconut Oil | 20.05 | 21.91 | 18.91 | 21.91 | 20.51 |
| Process Water | 29.62 | 31.62 | 24.77 | 31.63 | 28.43 |
| Total | 100.00 | 100.00 | 100.00 | 100.00 | 100.00 |

††REZISTA ® starch (Tate & Lyle)
‡ACCUBIND ® starch (Cargill)
‡‡STAR-DRI ® 10 (Tate & Lyle)
†ARTESA ® (Nutriati)

To prepare each of Ex. Slice 5A, Ex. Slice 7A, and Ex. Slice 8A, Ex. Blend E, Ex. Blend G, or Ex. Blend H (as applicable) was prepared as described above in Example 3. A starch slurry was prepared by combining the starch water (i.e., water to be used in the starch slurry) with the modified starch and the hydrophobic starch. The process water, salt, sorbic acid, chickpea protein, maltodextrin, and coconut oil were added to a Thermomix® TM6™ thermomixer, and the thermomixer was heated to 185° F., while the mixing speed was gradually increased from 0.5 to 3.0 to create a vortex. Then, the mixing was stopped, and the sides of the thermomixer were scraped. Ex. Blend E, Ex. Blend G, or Ex. Blend H (as applicable) was added to the thermomixer, the thermomixer was heated to 185° F., while mixing at a speed of 3.0, and held at 185° F. for 2 to 5 minutes until a homogenous mixture was formed. The homogenous mixture was transferred to a Silverson L4R Laboratory Mixer (scraping the sides and bottom of the thermomixer) and mixed at a mixing speed of 8 for 2 minutes, before transferring the mixture back to the thermomixer. Then, the thermomixer was heated to 185° F., while mixing at a speed of 3.0. The starch slurry was added to the thermomixer, and the thermomixer was heated to 185° F., while mixing at a speed of 3.0. Then, the mixing was stopped, and the sides of the thermomixer were scraped. Then, the thermomixer was at 185° F. for 2 minutes. Then, the heated mixture was filled into a box and allowed to cool to form a block of the example plant-based cheese product.

Ex. Slice 7B and Ex. Slice 8B were each prepared as described above except that the mixture was not transferred to the Silverson mixer because the mixture was too thick for the Silverson mixer.

Each of the example plant-based cheese products was placed between two slices of bread and grilled to produce a grilled cheese type product. Each of the example plant-based cheese products melted.

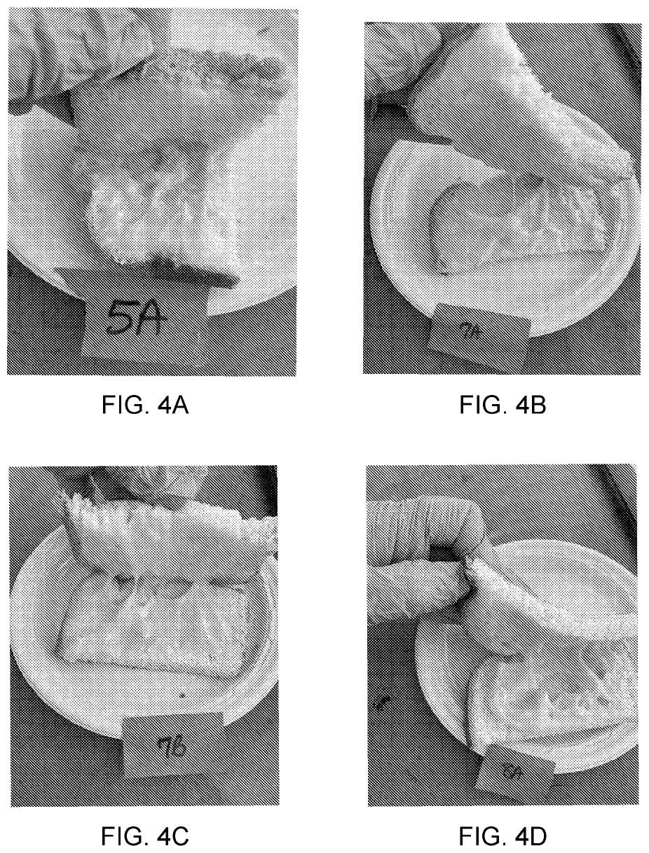

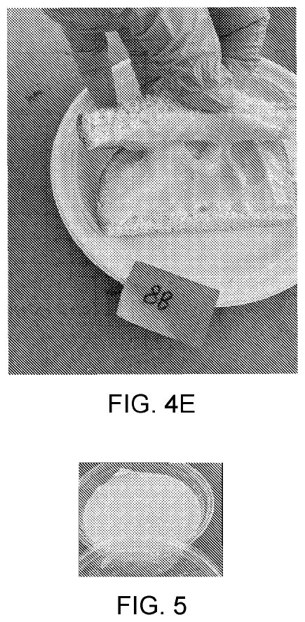

Ex. Slice 5A was spread on the bread because it was too soft to slice. Ex. Slice 5A was very thick upon melting and did not provide the desired stretch. The grilled cheese type product with Ex. Slice 5A is shown in FIG. 4A.

Ex. Slice 7A was soft but able to be sliced. Ex. Slice 7A had a creamy melt and had desirable stretch when melted. Ex. Slice 7A is shown in FIG. 4B.

Ex. Slice 7B was spread on the bread because it was too soft to slice. Ex. Slice 7B had a creamy melt and had desirable stretch when melted but was thick when melted. Ex. Slice 7B is shown in FIG. 4C.

Ex. Slice 8A was spread on the bread because it was too soft to slice. Ex. Slice 8A had a creamy melt and had desirable stretch when melted but was very thick when melted. Ex. Slice 8A is shown in FIG. 4D.

Ex. Slice 8B was spread on the bread because it was too soft to slice. Ex. Slice 8B had a creamy melt and had desirable stretch when melted but was very thick when melted. Ex. Slice 8B is shown in FIG. 4E.

### Comparative Example 5

Comparative example plant-based food products (referred to as “Comp. Ex. Blend K1,” “Comp. Ex. Blend K2,” “Comp. Ex. Blend K3,” “Comp. Ex. Blend L1,” “Comp. Ex. Blend L2,” and “Comp. Ex. Blend L3,”) were prepared. Each of the comparative examples included zein protein (FloZein™ zein protein isolate obtained from FloZein Products, about 82-100% crude protein by weight of the isolate), lactic acid, pea protein (VITESSENCE™ Pulse 1803 pea protein isolate obtained from Ingredion, about 80-100% crude protein by weight of the isolate), coconut oil, sunflower oil, and water. Comp. Ex. Blend K1, Comp. Ex. Blend K2, and Comp. Ex. Blend K3 each had a weight ratio of zein protein to lactic acid of 6:1. Comp. Ex. Blend L1, Comp. Ex. Blend L2, and Comp. Ex. Blend L3 each had a weight ratio of zein protein to lactic acid of 12:1.

Each of the comparative example plant-based food products was prepared using the formulations shown in Table 6, with the wt % of each ingredient that was used (based on the total weight of the plant-based food product).

TABLE 6

| | Comp. Ex. Blend | Comp. Ex. Blend |
|---|---|---|
| | K1, K2, & K3 | L1, L2, & L3 |
| Ingredient | (wt %) | (wt %) |
| Zein Protein* | 15.00 | 30.00 |
| Lactic Acid** | 2.50 | 2.50 |
| Pea Protein⋄ | 7.50 | 7.50 |
| Coconut Oil | 11.25 | 11.25 |
| Sunflower Oil | 3.75 | 3.75 |
| Water | 60.00 | 45.00 |
| Total | 100.00 | 100.00 |

*FloZein ™ (FloZein Products)
**88%, fermented
⋄VITESSENCETM Pulse 1803 (Ingredion)

To prepare Comp. Ex. Blend K1 and Comp. Ex. Blend L1, the water was heated to 105° F. in a Thermomix® TM6™ thermomixer. The pea protein was added and mixed with the water on low speed until blended. The mixture was heated to 194° F. and held at 194° F. for 7 minutes, while mixing on low. The mixture was allowed to cool to 110° F., with continuing stirring. Then, the coconut oil, sunflower oil, lactic acid, and zein protein was added. The mixture was mixed at 110° F. and low speed. The mixing speed was slowly increased at 2-minute intervals until the formulation came together. Then, the mixture was placed into a plastic container and allowed to set overnight.

Comp. Ex. Blend K1 was smooth but soft. Comp. Ex. Blend K1 could not be sliced and was dry and crumbly. Comp. Ex. Blend K1 is shown in FIG. 5.

To prepare Comp. Ex. Blend K2 and Comp. Ex. Blend L2, all of the ingredients were added in a Thermomix® TM6™ thermomixer and mixed on low with no heat until combined. The mixture was heated to 176° F., while mixing on low. Then, the mixture was placed into a plastic container and allowed to set for 24 hours.

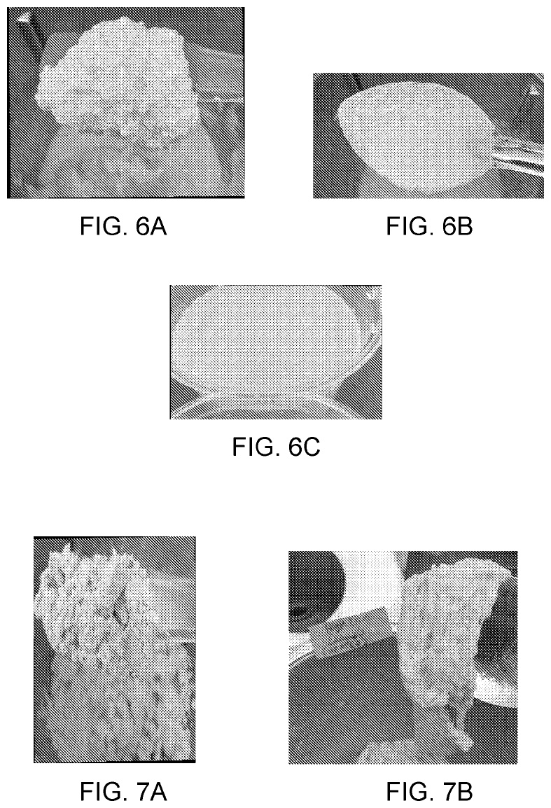

Before heating, Comp. Ex. Blend K2 was very thick and had no stretch. Comp. Ex. Blend K2 before heating is shown in FIG. 6A. After heating Comp. Ex. Blend K2 was liquidy and not smooth. Comp. Ex. Blend K2 after heating is shown in FIG. 6B. After 24 hours, Comp. Ex. Blend K2 was not smooth and had visible pockets of fat and unincorporated zein. Comp. Ex. Blend K2 could not be sliced and was dry and crumbly. Comp. Ex. Blend K2 after 24 hours is shown in FIG. 6C.

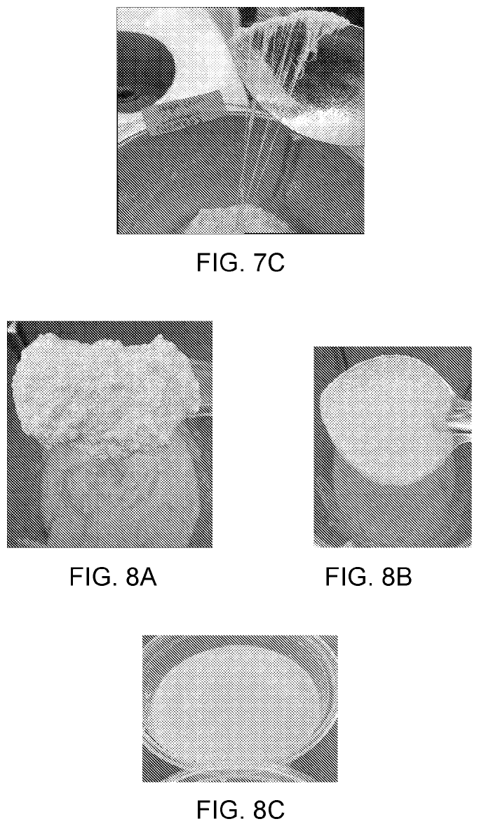

Before heating, Comp. Ex. Blend L2 had a dry and crumbly texture. Comp. Ex. Blend L2 before heating is shown in FIG. 7A. After heating Comp. Ex. Blend L2 was stretchy and stringy but not smooth and had visible unincorporated particulates of zein. Oil and water had separated from the mixture. Comp. Ex. Blend L2 after heating is shown in FIG. 7B and FIG. 7C.

To prepare Comp. Ex. Blend K3 and Comp. Ex. Blend L3, all of the ingredients were added in a Thermomix® TM6™ thermomixer and mixed on low with no heat until combined. The mixture was heated to 185° F., while mixing on low. Then, the mixture was placed into a plastic container and allowed to set overnight.

Before heating, Comp. Ex. Blend K3 was very thick and had no stretch but was slightly smoother than Comp. Ex. Blend K2. Comp. Ex. Blend K3 before heating is shown in FIG. 8A. After heating Comp. Ex. Blend K3 was liquidy and not smooth. Comp. Ex. Blend K3 after heating is shown in FIG. 8B. After 24 hours, Comp. Ex. Blend K3 was not smooth and had visible pockets of fat and unincorporated zein. Comp. Ex. Blend K3 could not be sliced and was dry and crumbly. Comp. Ex. Blend K3 after 24 hours is shown in FIG. 8C.

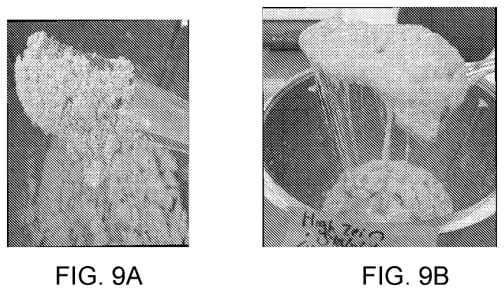

Before heating, Comp. Ex. Blend L3 had a dry and crumbly texture. Comp. Ex. Blend L3 before heating is shown in FIG. 9A. After heating Comp. Ex. Blend L3 was stretchy and stringy but not smooth and had visible unincorporated particulates of zein. Oil and water had separated from the mixture. Comp. Ex. Blend L3 after heating is shown in FIG. 9B.

It is to be understood that the ranges provided herein include the stated range and any value or sub-range within the stated range. For example, a range of about 5 wt % to about 15 wt % should be interpreted to include not only the explicitly recited limits of range of about 5 wt % to about 15 wt %, but also to include individual values, such as 6.35 wt %, 7.5 wt %, 10 wt %, 12.75 wt %, 14 wt %, etc., and sub-ranges, such as about 7 wt % to about 10.5 wt %, about 8.5 wt % to about 12.7 wt %, about 9.75 wt % to about 14 wt %, etc. Furthermore, when “about” is utilized to describe a value, this is meant to encompass minor variations (up to +/−10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. A plant-based food product comprising a prolamin-containing blend, the prolamin-containing blend comprising:
a prolamin;
a solvent component;
an incorporation component comprising one or more of a plant-based protein and a starch, wherein the plant-based protein is a non-prolamin protein;
a fat component; and
water;
wherein a weight ratio of the prolamin to the solvent component is within the range of 0.66:1 to 1.25:1, and wherein the prolamin is incorporated into the prolamin-containing blend.

2-3. (canceled)

4. The plant-based food product as defined in claim 2, wherein the incorporation component comprises starch in an amount within the range of about 1 wt % to about 20 wt %, based on the total weight of the prolamin-containing blend.

5. The plant-based food product as defined in claim 1, wherein the incorporation component comprises the plant-based protein.

6. (canceled)

7. The plant-based food product as defined in claim 5, wherein the plant-based protein comprises one or more of chickpea protein, fava protein, soy protein, mungbean protein, pea protein, canola protein, lentil protein, lupin protein, flax protein, legume protein, almond protein, walnut protein, sunflower protein, quinoa protein, algae protein, and mycelia protein.

8-10. (canceled)

11. The plant-based food product as defined in claim 5, wherein the plant-based protein is present in an amount within the range of about 1 wt % to about 12 wt % crude protein, based on the total weight of the prolamin-containing blend.

12. The plant-based food product as defined in claim 1, wherein the prolamin comprises one or more of zein, gliadin, hordein, secalin, kafirin, and avenin.

13. The plant-based food product as defined in claim 1, wherein the solvent component comprises one or more of lactic acid, acetic acid, benzyl alcohol, glycerol, propionic acid, oleic acid, palmitic acid, myristic acid, stearic acid, and propylene glycol.

14. (canceled)

15. The plant-based food product as defined in claim 1, wherein the fat component comprises one or more of coconut oil, palm oil, palm oil fraction, shea butter, shea olein, shea oil, shea stearin, sunflower oil, cocoa butter, soybean oil, canola oil, and cottonseed oil.

16. The plant-based food product as defined in claim 1, wherein the prolamin is present in an amount within the range of about 4.1 wt % to about 20 wt % crude protein, based on the total weight of the prolamin-containing blend.

17. The plant-based food product as defined in claim 1, wherein the solvent component is present in an amount within the range of about 4 wt % to about 25 wt %, based on the total weight of the prolamin-containing blend.

18. The plant-based food product as defined in claim 1, wherein the incorporation component is present in an amount within the range of about 10 wt % to about 30 wt %, based on the total weight of the prolamin-containing blend.

19. The plant-based food product as defined in claim 1, wherein the fat component is present in an amount within the range of about 10 wt % to about 35 wt %, based on the total weight of the prolamin-containing blend.

20. The plant-based food product as defined in claim 1, wherein the water is present in an amount within the range of about 20 wt % to about 35 wt %, based on the total weight of the prolamin-containing blend.

21. (canceled)

22. The plant-based food product as defined in claim 1, wherein the plant-based food product is a plant-based cheese product.

23-27. (canceled)

28. The plant-based food product as defined in claim 1, further comprising at least a hydrophobic starch and a modified starch.

29-41. (canceled)

42. A method of making a plant-based food product, comprising:
mixing a prolamin and solvent component to form a first mixture, wherein a weight ratio of the prolamin to the solvent component is within the range of 0.66:1 to 1.25:1;
adding an incorporation component to the first mixture to form a second mixture, wherein the incorporation component comprises one or more of a plant-based protein and a starch, the plant-based protein being a non-prolamin protein;
adding a fat component and water to the second mixture to form a prolamin-containing blend, wherein the prolamin is incorporated into the prolamin-containing blend.

43. The method as defined in claim 42, further comprising:
combining an additional fat with water, an additional protein, the prolamin-containing blend, and at least a hydrophobic starch and a modified starch to form a combination, wherein the additional fat has a solid fat content in the range of 30% to about 60% at 50° F. and 0% to about 10% at 92° F.;
blending the combination at a shear rate sufficient to provide a homogeneous mixture; and
heating the combination at a temperature within the range of about 160° F. to about 215° F.

44-52. (canceled)

53. A method of making a plant-based food product, comprising:
mixing a prolamin, solvent component, an incorporation component, a fat component, and water to form a prolamin-containing blend;
wherein a weight ratio of the prolamin to the solvent component is within the range of 0.66:1 to 1.25:1;
wherein the incorporation component comprises one or more of a plant-based protein and a starch, the plant-based protein being a non-prolamin protein; and
wherein the prolamin is incorporated into the prolamin-containing blend.

54. The method as defined in claim 53, further comprising:
Combining an additional fat with water, an additional protein, the prolamin-containing blend, and at least a hydrophobic starch and a modified starch to form a combination, wherein the additional fat has a solid fat content in the range of 30% to about 60% at 50° F. and 0% to about 10% at 92° F.;
blending the combination at a shear rate sufficient to provide a homogeneous mixture; and
heating the combination at a temperature within the range of about 160° F. to about 215° F.
